(19) United States
(12) Patent Application Publication
(10) Pub. No.: US 2013/0189559 A1
(43) Pub. Date: Jul. 25, 2013

(54) Frame System for Battery Cells and Battery Module

(71) Applicant: Peter Giere, Edemissen (DE)

(72) Inventor: Peter Giere, Edemissen (DE)

(73) Assignee: VOLKSWAGEN AKTIENGESELLSCHAFT, Wolfsburg (DE)

(21) Appl. No.: 13/825,882

(22) PCT Filed: Aug. 13, 2011
(86) PCT No.: PCT/EP2011/004084

§ 371 Date: Mar. 25, 2013

(30) Foreign Application Priority Data
Sep. 24, 2010 (DE) 10 2010 046 529.1

(51) Int. Cl. H01M 2/10; H01M 10/50

(52) U.S. Cl. CPC H01M 2/1077; H01M 10/5044
USPC 429/120; 429/159

(57) ABSTRACT

A quadrangular frame system for accommodating at least one battery cell and a battery module with the quadrangular frame system. The frame system is characterized by good force transmission, inexpensive production and simple fitting.

The present invention relates to a quadrangular frame system designed to accommodate at least one battery cell, wherein the frame system has a first and a second pressure plate, which form two mutually opposed sides of the frame system, and a first and a second side part, which form the further two sides of the frame system located between the two pressure plates, and wherein the respective side parts are fastened in the region of the corners of the frame system to the pressure plates. The invention also relates to a battery module, which has a quadrangular frame system and at least one battery cell, which is encompassed by the quadrangular frame system.

A battery cell, for example a lithium cell, typically has operating voltages in the single-digit volt range, in particular between 2.5 and 5 volts. For the operation of vehicles, higher voltages are required however. For high-voltage battery systems of vehicles, individual cells are therefore combined to form modules and are connected in series in order to achieve a voltage level suitable for the drive concept. Prismatic, for example cuboidal, lithium cells in particular tend to form a cell bulge depending on the charged state, temperature and aging. With battery cells, in particular with battery cells of a battery module arranged side-by-side, this leads to a linear expansion, which requires a larger installation space. The power and service life of the battery cells is also influenced negatively by the formation of the cell bulge.

In order to compact battery modules, that is to say to prevent a linear expansion on account of the cell bulges, it is known to provided battery modules with a frame. A battery module that has a frame is thus disclosed in EP 0 732 759 B1. This frame consists of two end plates and a number of connecting elements of strip-like structure connecting the end plates. Here, the end plates have a rectangular flat plate portion, which bears against the respective outermost battery cells of the battery module, and a rectangular frame portion, which protrudes continuously from the four sides of the flat plate portion. Here, the connecting elements are connected to the rectangular frame portion of the end plate. To fasten the connecting elements to the outer sides of the rectangular frame portion, holes are provided on the ends of the connecting elements and run perpendicular to the longitudinal extension of the connecting element. To fix the connecting elements to the rectangular frame portion, bolts are inserted through the holes in the connecting elements and are passed through into holes in the rectangular frame portion of the end plates, these holes being aligned correspondingly with the holes in the connecting elements. The connection is thus made perpendicular to a possible expansion of the battery module caused by the formation of cell bulges. This leads to shear forces at the connection points, in particular in the walls of the holes or in the bolts, which may destroy the connection. Furthermore, it is clear from EP 0 732 759 B1 that the sides of the end plate is connected to a plurality of strip-like connecting elements, in particular two or more strip-like connecting elements. With an external application of force, for example in the event of a road accident, the frame may distort, and the integrity of the battery module may be lost during this process.

The object of the invention is to create a simple quadrangular frame system of the type described in the introduction for accommodating at least one battery cell, with which the fastening regions or fastening points between the pressure plates and the side parts are relived of load, and which provides a high level of security with an external application of force.

This object is achieved in accordance with the invention by a quadrangular frame system for accommodating at least one battery cell having the features according to independent patent claim 1 of the patent application. The object is also achieved by a battery module according to patent claim 12. Further features and details of the invention will emerge from the dependent claims, the figures and the description. Features and details that are described in conjunction with the quadrangular frame system are, of course, also applicable here in conjunction with the battery module, and vice versa, and therefore, with regard to the disclosure, reference is always made reciprocally to the individual aspects of the invention.

In accordance with the first aspect of the invention, the object is achieved by a quadrangular frame system for accommodating at least one battery cell. Here, the quadrangular frame system consists of a first and a second pressure plate, which form two mutually opposed sides of the frame system. The pressure plates are arranged in this case at the region of the battery cell or the stack of battery cells at which the formation of a cell bulge is to be prevented. Furthermore, the quadrangular frame system has a first and a second side part, which form the further two sides of the frame system between the two pressure plates. The side parts are fastened in the region of the corners of the frame system to the pressure plates. Tabs are attached in a canted manner to the ends of each side part facing the pressure plates and are designed in such a way that they can engage the pressure plates from behind in an interlocking manner. Here, the tabs may be produced by a deformation, in particular a bending, of the side parts. In the assembled state of the quadrangular frame system, the tabs bear against the sides of the pressure plates that face away from the interior of the frame system. Due to the fact that the tabs bear against the outer sides of the pressure plates, said tabs are fastened in an interlocking manner to the pressure plates, and, with an accurate fit, in particular after installation of the at least one battery cell, the tabs can also be held on the pressure plates in a force-locked manner. Due to the fact that the tabs bear in a planar manner against the outer sides of the pressure plates, the tensile load in the case of the formation of a cell bulge with the at least one battery cell is conveyed directly into the side parts via the tabs. A decisive load relief of the fastening regions or of the fastening points is thus achieved, since the tensile force of the side parts does not bear directly thereagainst in the form of shear force. Due to the interlocking engagement of the tabs and the side parts with the pressure plates or the engagement from behind of the pressure plates by the tabs of the side parts, the connection rigidity of the quadrangular frame system is also increased. In particular, increased protection against an external application of force in the event of an accident can thus be produced. Due to the specific embodiment of the side parts and the fastening of the side parts to the outer sides of the pressure plates, a high primary pressure and a high retaining force are ensured. The pressure plates can be loaded by flexural stress during bulging of the battery cells, and thus introduce tensile forces into the side parts of the quadrangular frame system. The bracing of the side parts or of the pressure plates associated with the specific fixing of the side parts to the pressure plates ensures a high level of support in the transverse direction. A quadrangular frame system formed in this way is compact and modular so that it can be reliably built in universally in the respective available installation space, even in a number of planes. The side parts and the pressure plates of the quadrangular frame system can be held together merely by the compressive and tensile forces occurring with an encasement of at least one battery cell.

In a particularly preferred embodiment of the invention, the quadrangular frame system is formed as a rectangular frame system. In this embodiment, the tabs are attached in a canted manner perpendicularly to the side parts. The tensile load can be transferred from the pressure plates onto the side parts particularly effectively in this embodiment. The rectangular frame system for one or more battery cells is thus particularly stable.

In accordance with a further preferred embodiment of the invention, the tabs of the side parts of the quadrangular frame system each have at least one recess, and the pressure plates have openings. Here, the recesses and the openings are arranged in pairs, aligned with one another. This allows a fastening element to engage through a recess in a tab into the respective, aligned opening on the pressure plate. Each tab is fastened via the provided fastening elements to a pressure plate, in particular to the side of a pressure plate facing away from the interior of the frame system, and thus fixes the side parts securely to the pressure plates. Screws, rivets and/or pins may be provided as fastening elements. Due to this additional fastening, a particularly stable connection is produced between the side parts and the pressure plate.

In a particularly preferred development of the invention, with the quadrangular frame system the recesses in the tabs may be formed as a through-bore and/or the openings in the pressure plates may be formed as indentations. Here, the indentations in the pressure plates may be formed as blind bores and/or socket openings. In this embodiment of the invention, it is ensured that the fastening elements engage through the tabs into the openings in the pressure plates, however the fastening elements are not passed through the pressure plates into the interior of the quadrangular frame system. An influence of the fastening element onto the abutting battery cell, in particular a destruction of the outer sleeve of the battery cell, can thus be effectively avoided.

In accordance with a further preferred development of the invention, with the quadrangular frame system the recesses in the tabs and/or the openings in the pressure plates may have an inner thread for accommodating fastening screws. By screwing in fastening screws into the recesses in the tabs and into the openings in the pressure plates, the fastening screws can be fixed therein particularly securely. It is thus possible to entirely rule out the possibility that the fastening screws will fall out, as would be possible with simple metal pins.

Furthermore, the quadrangular frame system preferably has pressure plates and/or side parts, which are formed as an extruded profile. With this type of production, a metal material, which has been heated to forming temperature, is pressed through an extrusion die. Even profiles in complicated shapes, in particular with cavities, can thus be produced quickly and monolithically in one method step at low cost.

In accordance with a particularly preferred embodiment of the invention, the first and the second pressure plate of the quadrangular frame system can be formed identically. Furthermore, the first and the second side part of the quadrangular frame system may also be formed identically. The identical formation of the component parts of the quadrangular frame system allows a reduction of the production costs, since there is no need for different production methods and/or die shapes for each of the first and second component parts. The production costs are thus lowered. The assembly of the frame system is also facilitated, since there is no chance of confusion with the use of identical component parts.

Furthermore, with the quadrangular frame system, bracing elements may be provided on the pressure plates and/or on the side parts of the quadrangular frame system. These bracing elements can be produced for example as grooves in the side parts. As a result of these bracing elements, the torsional rigidity and the connection rigidity of the component parts are increased in particular. This increases the reliability of the quadrangular frame system in the case of an external application of force, for example in the case of an accident.

A quadrangular frame system with which the tabs of a side part are formed in one piece therewith, in particular are formed monolithically therewith, is particularly preferred. Due to the monolithic design, an otherwise necessary fastening of the tabs to the side parts is avoided. This makes the manufacturing process easier and less cost-intensive. In particular, the side parts inclusive of the tabs can be produced in a single production process by casting a casting material into a prefabricated casting mold.

In accordance with a further preferred development of the invention, with the quadrangular frame system the side parts of the quadrangular frame system may have tabs directed to the interior of the frame system on the lengthwise upper and/or lower edges. The at least one battery cell can be grasped in an interlocking manner on the upper side and/or underside by these additional tabs, the transverse extension of which runs preferably perpendicular to the tabs engaging the pressure plates from behind. It is thus possible to additionally stabilize the battery cell(s).

Furthermore, in accordance with a further embodiment of the invention, the quadrangular frame system may have a base plate or a cooling plate. Due to a base plate, the frame system is additionally reinforced and braced. The reliability in the case of an accident is thus increased. The base plate is particularly preferably formed as a cooling plate in order to guide redundant heat, which is produced during operation of the battery cells, away from the battery cells. The thermal load of the battery cells is thus lowered, and the efficiency and service life of the battery cells is increased.

In accordance with a second aspect of the invention, the object is achieved by a battery module comprising a quadrangular frame system and at least one battery cell, wherein the quadrangular frame system is formed in accordance with at least one variant of the first aspect of the invention. Due to the use of a frame system according to the invention for accommodating or framing at least one battery cell, the at least one battery cell is prevented from forming a cell bulge. The power and the service life of the battery cell(s) is thus increased. Furthermore, due to the embodiment according to the invention of the frame system, the reliability with an external application of force, for example in the case of an accident, is considerably increased. Due to the use of a frame system according to the invention, the production costs of the battery module are also lowered and the assembly of the battery module is facilitated.

Further advantages, features and details of the invention will emerge from the following description, in which exemplary embodiments of the invention are described in detail with reference to the drawings. Here, the features mentioned in the claims and in the description are each essential to the invention, either individually or in any combination. In the drawings:

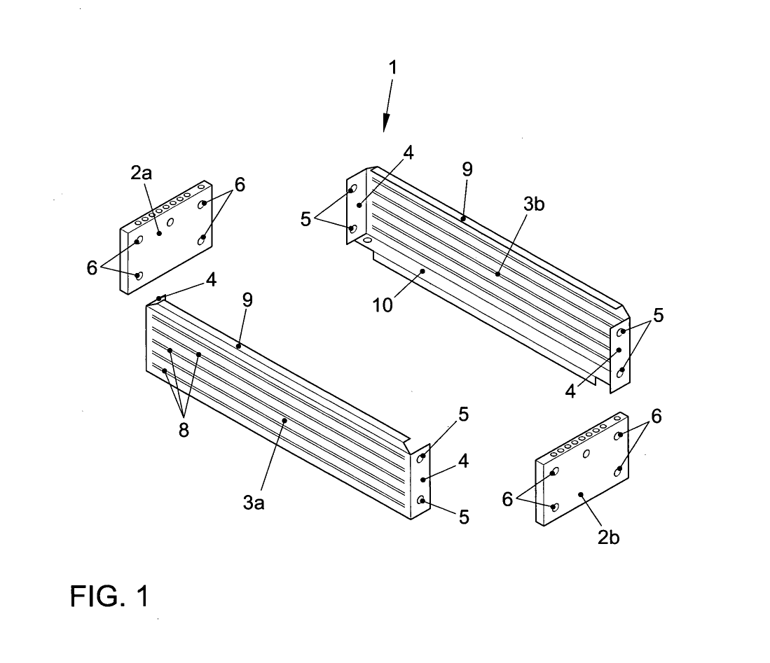

FIG. 1: shows a perspective view of a quadrangular frame system formed in accordance with the construction principle according to the invention, and

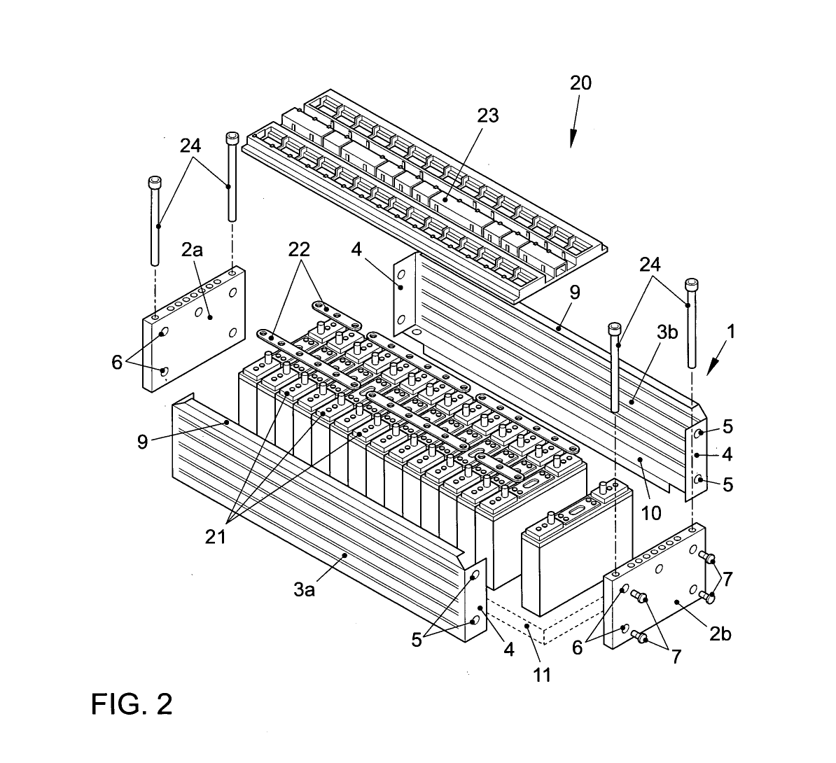

FIG. 2: shows a perspective view of a battery module with battery cells and a quadrangular frame system, which is formed in accordance with the construction principle according to the invention.

Elements with like function and operating principle are provided with like reference signs in FIGS. 1 and 2.

FIG. 1 shows a perspective schematic illustration of the individual parts of the quadrangular frame system 1. Here, the first and the second pressure plate 2a, 2b and the first and the second side part 3a, 3b can be seen. Each of the pressure plates 2a, 2b and each of the side parts 3a, 3b are formed identically in this case. Furthermore, each of the four component parts 2a, 2b, 3a, 3b forms a respective monolithic component part. A tab 4 is attached in a canted manner to each of the ends of the side parts 3a, 3b facing the pressure plates 2a, 2b. In this embodiment of the quadrangular frame system 1, the tabs 4 are attached in a canted manner by a bent deformation. Recesses 5 are provided in the tabs 4. These recesses are aligned with the openings 6 in the pressure plates 2 in the assembled state of the quadrangular frame system 1. This enables a connection of the tabs 4 of the side parts 3 to the pressure plates 2 via connection elements (not illustrated). Here, the tabs 4 are arranged such that they bear against the pressure plates 2a, 2b on the side of the pressure plates facing away from the inner face of the quadrangular frame system 1. Scooped elements 8 are attached to the side parts 3a, 3b. In the embodiment shown of the quadrangular frame system 1, the scooped elements 8 are formed as grooves. These are used as an additional bracing of the side parts 3a, 3b. Upper tabs 9 are attached in a canted manner to the side parts 3a, 3b at the upper sides thereof. These tabs are used to grasp the upper sides of battery cells. It is thus not possible for battery cells to fall out from the quadrangular frame system 1. Furthermore, lower tabs 10 are attached in a canted manner to the lower edges of the side parts 3a, 3b. These lower tabs 10 are used to encompass the undersides of battery cells 21. Battery cells can thus likewise be prevented from falling out downwardly from the quadrangular frame system 1.

FIG. 2 shows a schematic perspective exploded view of a battery module 20, which has a quadrangular frame system 1 as described in FIG. 1. In addition to the pressure plates 2a, 2b and the side parts 3a, 3b, battery cells 21 form the main part of the battery module 20. Here, the battery cells 21 are arranged in succession on a base plate 11 of the quadrangular frame system 1. The electrical contacts of the battery cells 21 are interconnected by means of pole connectors 22. A contact plate 23 is used to cover the upper side of the battery cells 21. In the assembled state, the pressure plates 2a, 2b bear against the sides of the first and the last battery cell 21 facing said pressure plates. The side parts 3a, 3b bear against the sides of the battery cells 21 facing said side parts. Here, the upper tabs 9 of the side parts 3a, 3b may additionally encompass the contact plate 23 in an interlocking manner. The lower tabs 10 of the side parts 3a, 3b advantageously encompass the base plate 11 of the battery module 20 in an interlocking manner. The tabs 4 of the side parts 3a, 3b are arranged on the side of the pressure plate 2a, 2b facing away from the inner face of the quadrangular system 1 in such a way that the recesses 5 in the tabs 4 and the openings 6 in the pressure plates 2a, 2b are each aligned in pairs. It is thus possible for the fastening elements 7 to fix the connection between the tabs 4 and the pressure plates 2a, 2b particularly effectively. The entire assembled battery module 20 can be fastened in its intended location, for example a vehicle, via fastening bolts 24. Due to the connection of the pressure plates 2a, 2b to the side parts 3a, 3b via the tabs 4, the tensile load caused by possible cell bulges of the battery cells 21 is transferred via the interlocking engagement of the tabs 4 from the pressure plates 2a, 2b into the side parts 3a, 3b. Here, there is no additional loading caused by shear forces at the fastening elements 7. Due to the identical embodiment of both the first side part 3a and the second side part 3b and also of the two pressure plates 2a, 2b, the quadrangular frame system 1 can be produced cost-effectively. Due to the avoidance of confusion with different side parts 3a, 3b and/or pressure plates 2a, 2b, the assembly of the quadrangular frame system 1 is facilitated. Due to the interlocking manner in which the contact plate 23 is encompassed by the upper tabs 9 and the base plate 11 is encompassed by the lower tabs 10, a stable and secure construction of the battery module 20 is produced. Scooped elements 8 in the side parts 3a, 3b additionally increase the torsional rigidity of the battery module 20 as a whole. A battery module 20 designed in such a way therefore has increased reliability with an external application of force, in particular in the event of accidents.

Due to the fact that the tabs 4 bear in a planar manner against the outer sides of the pressure plates 2a, 2b, the tensile load in the case of the formation of a cell bulge with the battery cells 21 is conveyed directly into the side parts 3a, 3b of the quadrangular frame system 1 via the tabs 4. A decisive load relief of the fastening regions or of the fastening points is thus achieved, since the tensile force of the side parts 3a, 3b does not bear directly thereagainst in the form of shear force. Due to the interlocking engagement of the tabs 4 and the side parts 3a, 3b with the pressure plates 2a, 2b or the engagement from behind of the pressure plates 2a, 2b by the tabs 4 of the side parts 3a, 3b, the connection rigidity of the quadrangular frame system 1 is increased. In particular, increased protection against an external application of force in the event of an accident can thus be produced. Due to the specific embodiment of the side parts 3a, 3b and the fastening of the side parts 3a, 3b to the outer sides of the pressure plates 2a, 2b, a high primary pressure and a high retaining force are ensured. The pressure plates 2a, 2b can be loaded by flexural stress during bulging of the battery cells 21, and thus introduce tensile forces into the side parts 3a, 3b of the quadrangular frame system 1. The bracing of the side parts 3a, 3b or of the pressure plates 2a, 2b associated with the specific fixing of the side parts 3a, 3b to the pressure plates 2a, 2b ensures a high level of support in the transverse direction. A quadrangular frame system 1 formed in this way is compact and modular so that it can be reliably built in universally in the respective available installation space, even in a number of planes.

### LIST OF REFERENCE SIGNS

1 quadrangular frame system
2a first pressure plate
2b second pressure plate
3a first side part
3b second side part
4 tab
5 recess in tab
6 opening in pressure plate
7 fastening element
8 scooped element
9 lower tab
10 upper tab
11 base plate
20 battery module
21 battery cells
22 pole connector
23 contact plate
24 fastening bolt

1-10. (canceled)

11. A quadrangular frame system having an interior space for accommodating at least one battery cell, the frame system comprising:
first and second pressure plates forming two mutually opposed sides of the frame system
first and second side parts forming two further sides of the frame system, said first and second side parts extending between said first and second pressure plates and each having ends facing said first and second pressure plates, respectively, and being attached to said first and second pressure plates at corners of the frame system;
tabs formed in a canted manner to said ends of each of said first and second side parts and engaging said pressure plates from behind with a form lock, with said tabs bearing against the respective sides of said pressure plates facing away from the interior of the frame system, and said tabs being fastened to the respective said pressure plates with at least one or both of a force-locking or form-locking engagement.

12. The quadrangular frame system according to claim 11, wherein each of said tabs is formed with at least one recess and said pressure plates are formed with openings, wherein a respective said opening is aligned with a recess in a respective said tab, and wherein respective fastening elements engage through a recess in a respective said tab into the respectively aligned opening in a respective said pressure plate.

13. The quadrangular frame system according to claim 12, wherein said at least one recess in a tab is a through-bore, said openings in the pressure plates are formed as recesses or indentations.

14. The quadrangular frame system according to claim 12, wherein said at least one recess in a tab has an inner thread for meshing with fastening screws, and/or wherein said openings in said pressure plates have an inner thread for meshing with fastening screws.

15. The quadrangular frame system according to claim 11, wherein at least one of said pressure plates or said side parts are formed from extruded profiles.

16. The quadrangular frame system according to claim 11, which comprises reinforcing elements formed on at least one of said pressure plates or said side parts.

17. The quadrangular frame system according to claim 11, wherein said tabs and said side parts are formed integrally in one piece.

18. The quadrangular frame system according to claim 17, wherein said tabs and said side parts are formed monolithically with each other.

19. The quadrangular frame system according to claim 11, wherein tabs directed to the interior of the frame system are provided on the lengthwise upper and/or lower edges of the side parts.

20. The quadrangular frame system according to claim 11, which further comprises a base plate or a cooling plate.

21. A battery module, comprising:
a quadrangular frame system according to claim 11; and
one or more battery cells in the interior of and encompassed by the quadrangular frame system.
